(19) United States
(12) Patent Application Publication
(10) Pub. No.: US 2023/0201990 A1
(43) Pub. Date: Jun. 29, 2023

(54) CHANGING STATION, METHOD FOR CHANGING SANDPAPER AND ROBOT SYSTEM

(71) Applicant: OnRobot A/S, Odense SØ (DK)

(72) Inventors: Ákos TAR, Odense SØ (DK); Donát HEGYESI, Odense SØ (DK); Zsófia MÁNDI, Odense SØ (DK)

(21) Appl. No.: 18/116,045

(22) Filed: Mar. 1, 2023

Related U.S. Application Data
(63) Continuation of application No. PCT/DK2021/050266, filed on Aug. 31, 2021.

(30) Foreign Application Priority Data
Sep. 2, 2020 (DK) PA 2020 00989
Mar. 2, 2021 (DK) PA 2021 00221

(51) Int. Cl. B24B 27/04; B25J 11/00; B25J 18/04

(52) U.S. Cl. CPC B24B 27/04; B25J 11/0065; B25J 18/04

(57) ABSTRACT

A method for automatically attaching a surface treatment medium to a head of a surface treatment tool mounted on an articulated arm of a robot is disclosed. The method comprises placing the head on a surface and applying a predefined force to press the head towards the surface when no surface treatment medium is attached to the head, measuring the distance between the head and the surface using one or more positioning sensors of the robot arm or the surface treatment tool, attaching a surface treatment medium to the head, placing the head on the surface when the surface treatment medium is attached to the head, and measuring the distance between the head and the surface using one or more positioning sensors of the robot arm or the surface treatment tool when the surface treatment medium is attached to the head.

### CROSS-REFERENCE TO RELATED APPLICATIONS

This application is a continuation under 35 U.S.C. 111 of International Patent Application No. PCT/DK2021/050266, filed Aug. 31, 2021, which claims the benefit of and priority to Danish Application Nos. PA 2021 00221, filed Mar. 2, 2021, and PA 2020 00989, filed Sep. 2, 2020, each of which is hereby incorporated by reference in its entirety.

### FIELD OF INVENTION

The present invention relates to a changing station (grit changer) for changing a surface treatment media (e.g. a sheet member such as sandpaper) from a robot mounted surface treatment tool. The present invention also relates to a method for changing a surface treatment media from a robot mounted surface treatment tool.

### BACKGROUND

There has recently been an increasing use of robot-assisted machining of surfaces. Grinding machines such as orbital grinding machines are typically employed in industries. In orbital grinding machines a rotational movement around an axis of rotation is superimposed over an oscillation movement. Grinding machines are typically applied for the final processing of surfaces when high demands are placed on the quality of the finished surface.

In many situations, robot-supported grinding apparatuses comprise a grinding tool such as an orbital grinding machine guided by an industrial robot. Grinding machines such as orbital grinding machines operate with sheet-formed, flexible and removable grinding discs (e.g. sandpaper) that are attached to a pad portion of a head of the grinding machine pad. There exist various types of grinding discs made of suitable materials such as paper or a fiber-reinforced material with a grained abrasive coating. The grinding discs are configured to be attached to the backing pad of the head of the grinding machine e.g. by a hook and loop fastener.

In robot-supported grinding devices, the grinding discs are often changed manually. There, however, exist various robot-supported changing stations for changing grinding discs. These solutions are, however, complex, require a great deal of effort to be realized and are therefore costly.

Thus, there is a need for an improved way of removing grinding discs from a grinding machine and mounting grinding discs onto a grinding machine.

Accordingly, it is an objective of the present invention to provide an improved method for removing grinding discs from a grinding machine and mounting grinding discs onto a grinding machine.

It is also an object to provide an improved robot-supported changing station for changing grinding discs.

### BRIEF DESCRIPTION

A method for automatically attaching a surface treatment media to a surface treatment tool mounted on a robot arm of a robot having an articulated robot arm is disclosed, wherein the surface treatment tool comprises a head configured to receive the surface treatment media. The method comprises placing the head on a surface and applying a predefined force to press the head towards the surface when no surface treatment media has been attached to the head, and:
measuring the distance between the head and the surface using one or more positioning sensors of the robot arm or the surface treatment tool;
attaching a surface treatment media to the head and placing the head on the surface when the surface treatment media is attached to the head; and
measuring the distance between the head and the surface using the one or more positioning sensors of the robot arm or the surface treatment tool when the surface treatment media is attached to the head.

Hereby, it is possible to provide a method for removing grinding discs from a grinding machine and mounting grinding discs onto a grinding machine. The method makes it possible to verify if a surface treatment media is attached to the head or not in a simple, reliable and fast manner.

The surface treatment tool may be a grinding machine such as an orbital grinding machine configured to be mounted on the robot arm. The grinding machine may be mounted on the robot arm by using a tool changer.

The surface treatment tool comprises a head configured to receive the surface treatment media. The head may comprise a pad.

The method comprises the step of placing the head on a surface and applying a predefined force to press the head towards the surface when no surface treatment media has been attached to the head. Since a predefined force is applied a corresponding deformation of the head is experienced.

The method comprises the step of measuring the distance between the head and the surface using one or more positioning sensors of the robot arm or the surface treatment tool. Hereby, it is possible to take advantage of the functions that the robot arm or the surface treatment tool provides. Accordingly, no additional functionality has to be added to the robot arm or to the surface treatment tool.

The method comprises the step of attaching a surface treatment media to the head and placing the head on the surface when the surface treatment media is attached to the head.

The method comprises the step of measuring the distance between the head and the surface using the one or more positioning sensors of the robot arm or the surface treatment tool when the surface treatment media is attached to the head.

Hereby, it is possible to verify if a surface treatment media is attached to the head or not in a simple, reliable and fast manner.

In an embodiment, the surface treatment media is a sheet member. The surface treatment media may be formed as a coated abrasive. In an embodiment, the surface treatment media is an abrasive grain bonded to a flexible substrate using adhesives. In an embodiment, the surface treatment media is sandpaper.

It may be advantageous that the method comprises the following steps:
detaching the surface treatment media from the head;
placing the head on the surface when the surface treatment media has been removed;
applying the predefined force to press the head towards the surface; and
measuring the distance between the head and the surface using the one or more positioning sensors of the robot arm or the surface treatment tool.

Hereby, it is possible to verify that the surface treatment media has been removed. If it has been verified that the surface treatment media has been removed a new piece of surface treatment media can be attached. If, however, it is not verified that the surface treatment media has been removed, the step of removing the surface treatment media from the head can be repeated.

It may be an advantage that the method comprises the step of detecting the orientation of the head by bringing the head into engagement with engagement structures.

Hereby, it is possible to make sure that the orientation of the surface treatment media being attached to the head is correct and corresponds to the desired orientation (in which the holes in the surface treatment media are aligned with holes in the head).

It may be beneficial that the head comprises several holes and the engagement structures comprise one or more detection pins arranged with a predefined mutual distance from each other or a predefined mutual distance from another structure that is arranged to be brought into engagement with a predefined structure of the head, wherein the one or more detection pins are configured to be brought into engagement with one or more holes of the head. Hereby, it is possible to arrange the head of a surface treatment tool in such a manner that the head of a surface treatment tool has a pre-defined and desired orientation.

In an embodiment, the head comprises several holes and the engagement structures comprise two detection pins arranged with a predefined mutual distance from each other, wherein the two detection pins are configured to be brought into engagement with the holes of the head.

In an embodiment, the head comprises several holes and the engagement structures comprise at least three detection pins arranged with a predefined mutual distance from each other, wherein the at least three detection pins are configured to be brought into engagement with the holes of the head.

It may be advantageous that the method comprises the step of applying a changing station that comprises a detachment portion configured to detach a surface treatment media from the head and an attachment portion designed and configured to attach a surface treatment media to the head.

In an embodiment, two guide pins are provided in an attachment portion and two detection pins are protruding from the surface of the detachment portion. Hereby, it is possible to provide a practical solution that makes it possible to arrange the head of a surface treatment tool in such a manner that the head of a surface treatment tool has a predefined and desired orientation.

In an embodiment, the method comprises the step of removing the surface treatment media from the head by moving the head along the surface of the detachment portion, wherein the detachment portion comprises a plate formed as a separation blade that is provided at a distance from the adjacent edge of the surface, wherein the plate is provided in a slightly higher level than the surface.

Hereby, a gap will be provided between the plate and the support member. It is essential that this gap is large enough to receive an edge portion of the surface treatment media.

In an embodiment, the step of removing the surface treatment media from the head can be accomplished by having the surface treatment media enter the gap between the plate and the support member and moving the robot mounted surface treatment tool in a direction along the surface of the support member towards the plate.

In an embodiment, the orientation of the head is detected by moving (rotating) the head until two holes in the head have been received by the two detection pins.

It may be an advantage that the method comprises the step of removing the lowermost surface treatment media by bringing at least the most distal portion of the head into contact with a media holder and moving the head along the length of the media holder.

It may be an advantage that, in case it has been detected that more than one surface treatment media have been attached to the head, the method comprises the step of removing the lowermost surface treatment media by bringing at least the most distal portion of the head into contact with a removal structure and moving the head along the length of the removal structure.

In an embodiment, the media holder is formed as a pin that comprises alternating portions of protruding structures and groove structures.

In an embodiment, the depth of the groove structure relative to the protruding structure is in the range 0.01-5 mm.

In an embodiment, the depth of the groove structure relative to the protruding structure is in the range 0.04-4 mm.

In an embodiment, the depth of the groove structure relative to the protruding structure is in the range 0.08-3 mm.

In an embodiment, the depth of the groove structure relative to the protruding structure is in the range 1.0-2.0 mm.

It is important to emphasize that the groove depth can be set based on the thickness of the surface treatment media.

The changing station disclosed herein is a changing station for automatically attaching a surface treatment media to a surface treatment tool mounted on a robot arm of a robot having an articulated robot arm, wherein the surface treatment tool comprises a head configured to receive the surface treatment media, wherein the changing station comprises a detachment portion and an attachment portion, wherein the detachment portion comprises a support member configured to receive the head, wherein the detachment portion comprises two detection pins protruding from the support member and being arranged with a predefined mutual distance.

Hereby, it is possible to arrange the head of a surface treatment tool in such a manner that the head of a surface treatment tool has a predefined and desired orientation.

The head may comprise a pad made of a compressible material. Hereby, it is possible to allow the head to at least partly adapt to the shape of the object that is to be treated by the surface treatment media.

In an embodiment, the detachment portion and the attachment portion are integrated into a one-piece body.

In an embodiment, the changing station comprises a frame that surrounds at least a portion of the detachment portion and at least a portion of the attachment portion.

In an embodiment, the support member is substantially planar.

In an embodiment, the support member comprises a semi-circular portion.

It may be an advantage that the attachment portion comprises a base portion, wherein two guide pins protrude from the base portion, wherein the two guide pins are arranged with the same mutual distance as the two detection pins.

In an embodiment, the guide pins are detachably attached to the base portion. Hereby, it is possible to replace the guide pins with longer or shorter ones.

In an embodiment, the base portion is configured to receive a pair of detachably attached guide pins in various positions so that the position of the guide pins can be changed.

It may be advantageous that the attachment portion comprises a base portion configured to receive a stack of surface treatment media and that the attachment portion comprises a plurality of media holders shaped as pin-formed stop members that are arranged in a configuration in which the media holders surround the base portion.

In an embodiment, the media holders extend parallel to the guide pins and protrude from a frame surrounding the base portion.

In an embodiment, the media holders are formed and arranged to keep the correct surface treatment media orientation when a plurality of surface treatment media pieces are stacked in the attachment portion.

In an embodiment, the media holders have a cylindrical portion.

In an embodiment, the media holders have a proximal cylindrical portion and a distal rounded portion.

In an embodiment, several of the media holders comprise alternating portions of protruding structures and groove structures.

In an embodiment, at least a plurality of the media holders comprise alternating portions of protruding structures and groove structures.

It may be an advantage that the detachment portion comprises a separation blade that is provided at a distance from an adjacent edge of the support member, wherein the separation blade is provided at a higher level than the support member.

A robot system disclosed herein is a robot system comprising:
a changing station;
a robot comprising a robot arm; and
a surface treatment tool attached to the robot arm,
wherein the robot system is configured to automatically attach a surface treatment media to the surface treatment tool, wherein the surface treatment tool comprises a head configured to receive the surface treatment media, wherein the robot system is configured to place the head on a surface and apply a predefined force to press the head towards the surface when no surface treatment media has been attached to the head.

It may be an advantage that the robot system comprises:
a measuring unit configured to measure the distance between the head and the support member using one or more positioning sensors of the robot arm or the surface treatment tool;
an attachment unit configured to attach a surface treatment media to the head and to place the head on the support member when the surface treatment media is attached to the head,
wherein the measuring unit is configured to measure the distance between the head and the support member when the surface treatment media is attached to the head and the head is placed on the support member.

In an embodiment, a predefined force is applied to press the head against the support member when measuring the distance between the head and the support member.

In an embodiment, the plate and the separation blade are attached to each other. In an embodiment, the plate and the separation blade are integrated to constitute a one-piece body.

In an embodiment, the separation blade is movably arranged with respect to the support member. Hereby, the magnitude of the gap can be changed by moving the separation blade. Attachment of the separation blade may be carried out using screws or other attachment members.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 shows a perspective view of a changing station according to an embodiment;

FIG. 2 shows a schematic side view of a changing station according to an embodiment arranged next to a robot;

FIG. 3A shows a changing station according to an embodiment;

FIG. 3B shows another view of the changing station shown in FIG. 3A;

FIG. 4A shows another view of the changing station shown in FIG. 3A and FIG. 3B;

FIG. 4B shows another view of the changing station shown in FIG. 3A and FIG. 3B;

FIG. 5 shows another view of the changing station shown in FIG. 4B;

FIG. 6A shows a cross-sectional view of a detachment portion of a changing station according to an embodiment;

FIG. 6B shows another cross-sectional view of the detachment portion shown in FIG. 6A;

FIG. 6C shows another cross-sectional view of the detachment portion shown in FIG. 6B;

FIG. 6D shows another cross-sectional view of the detachment portion shown in FIG. 6C;

FIG. 7A shows a cross-sectional view of an attachment portion according to an embodiment;

FIG. 7B shows another cross-sectional view of a portion of the attachment portion shown in FIG. 7A;

FIG. 7B shows a cross-sectional view of a portion of the attachment portion shown in FIG. 7A;

FIG. 7C shows another cross-sectional view of the portion of the attachment portion shown in FIG. 7B;

FIG. 7D shows another cross-sectional view of a portion of the attachment portion shown in FIG. 7C; and

FIG. 7E shows another cross-sectional view of a portion of the attachment portion shown in FIG. 7D.

### DETAILED DESCRIPTION

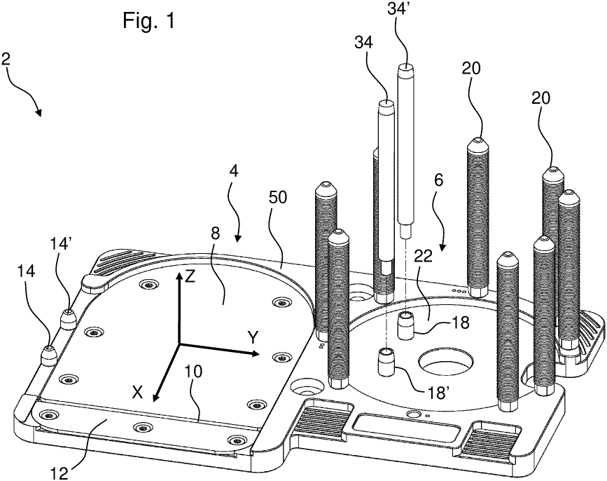

Referring now in detail to the drawings for the purpose of illustrating embodiments of the present invention, a changing station 2 is illustrated in FIG. 1.

FIG. 1 is a perspective view of a changing station 2 according to an embodiment. The changing station 2 comprises a frame 50 provided with a detachment portion 4 and an attachment portion 6.

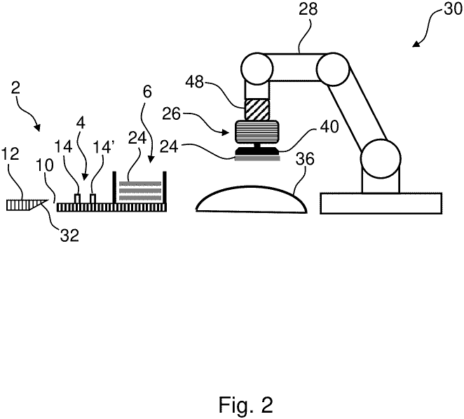

The detachment portion 4 comprises a plate-shaped support member 8 configured to receive a surface treatment media 24 (e.g. a sheet member such as sandpaper shown in FIG. 2) attached to the distal end of a robot mounted surface treatment tool (e.g. a grinding machine shown in FIG. 2). The support member 8 is provided at a lower level than the frame 50 that is surrounding a large portion of the support member 8. The support member 8 is configured to receive a circular surface treatment media and to allow the circular surface treatment media to be moved along the support member 8 in order to remove the surface treatment media from the support member 8. Three axes X, Y, Z of the detachment portion 4 are indicated.

The detachment portion 4 comprises a plate 12 formed as a separation blade that is provided at a short distance from the adjacent edge of the support member 8. The plate 12 is provided in a slightly higher level than the support member 8. Hereby, a gap (see FIG. 2) is provided between the plate 12 and the support member 8. This gap is large enough to receive an edge portion of the surface treatment media.

Removal of the surface treatment media from a head of a surface treatment tool like the one shown in FIG. 2 can be accomplished by bringing the surface treatment media in a position, in which an edge portion of the surface treatment media enters the gap between the plate 12 and the support member 8 and moving the robot mounted surface treatment tool in a direction along the surface of the support member 8 towards the plate 12 (along the X axis).

The detachment portion 4 comprises two detection pins 14, 14′ arranged with a predefined distance in order to use the detection pins 14, 14′ for detecting corresponding holes in a head of a surface treatment tool configured to receive the surface treatment media. Hereby, it is possible to arrange the head of a surface treatment tool in such a manner that the head of a surface treatment tool has a predefined and desired orientation.

The attachment portion 6 comprises a circular base portion (configured to receive the media) 24. Two mounting structures 18, 18′ are provided at base portion 22. The mounting structures 18, 18′ are shaped to receive detachably mounted guide pins 34, 34′. When mounted, the guide pins 34, 34′ protrude from the base portion 22 along the Z axis.

A plurality of media holders 20 shaped as pin-formed stop members 20 surround the base portion 22. The media holders 20 extend parallel to the mounting structures 18, 18′ and the guide pins 34, 34′ and protrude from the frame 50 surrounding the base portion 22. Each of the mounting structures 18, 18′ is provided with a distal female receiving structure configured to receive a matching male portion of the proximal portion of the corresponding guide pin 34, 34′.

The pin-formed media holders 20 are formed and arranged to keep the correct surface treatment media orientation when a plurality of surface treatment media pieces are stacked in the attachment portion 6.

The changing station 2 is provided with holes for being mounted to a mounting surface (e.g. a table or another working station).

During normal use, the changing station 2 is orientated in such a manner that the Z axis extends vertically.

FIG. 2 illustrates a schematic side view of a changing station 2 according to an embodiment arranged next to a robot 30. The robot 30 comprises an articulated robot arm 28. A surface treatment tool 26 is mounted to the robot arm 28. In the embodiment shown in FIG. 2, the surface treatment tool 26 is a grinding machine 26 comprising a head 40 formed as a pad configured to receive a sheet formed surface treatment media 24, such as sandpaper.

A sensor 48 configured to detect force and/or torque is attached to the robot arm 28 or alternatively integrated in the robot arm 28 or the surface treatment tool 26.

The surface treatment tool 26 is arranged above an object 36 that needs a surface treatment.

A changing station 2 according to an embodiment is arranged next to the robot 30. The changing station 2 corresponds to the one shown and explained with reference to FIG. 1. It can be seen that a plurality of surface treatment medias 24 are stacked in the attachment portion 6 of the changing station 2.

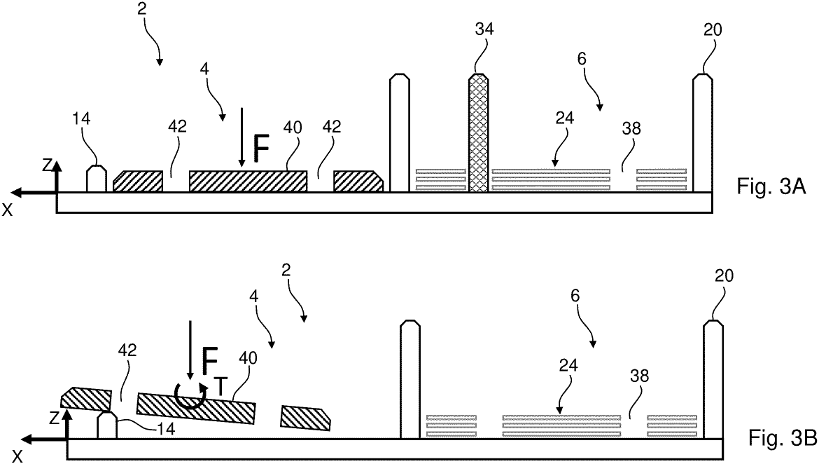

FIG. 3A illustrates a changing station 2 according to an embodiment in a configuration, in which a stack of surface treatment media 24 has been received by the attachment portion 6 of the changing station 2. The surface treatment media 24 are maintained within a receiving area of the attachment portion 6 of the changing station 2, wherein the receiving area is surrounded by media holders 20 provided as rod-shaped stop members 20.

It can be seen that each surface treatment medium 24 comprises holes 38 and that the attachment portion 6 comprises a guide pin 34 that extends through one of the holes in the surface treatment medium 24.

A head 40 of a surface treatment tool (not shown) rests on the support member of the detachment portion 4 of the changing station 2. A number of holes 42 are provided in the head 40. The holes 38 in the surface treatment media 24 are placed in such a manner that they can be aligned with the holes 42 provided in the head 40. Hereby, dust can be removed from a surface treatment medium 24 through these holes 38, 42 during use of the surface treatment medium 24.

The detachment portion 4 comprises two detection pins 14 (however, only one is visible in FIG. 3A) arranged with a predefined distance in order to use the detection pins 14 to detect corresponding holes 42 in a head 40 (see FIG. 2) and allow the detection pins 14 to be received in the holes 42. Hereby, it is possible to arrange the head 40 in a predefined and desired orientation.

FIG. 3B illustrates another view of the changing station 2 shown in FIG. 3A in a configuration, in which the holes 42 in the head 40 are being detected on the basis of force F and/or torque T data measured by a sensor corresponding to the one shown and explained with reference to FIG. 2. In practice, the robot arm rotates the surface treatment tool until the detection pins 14 have been received by holes 42 in the head 40 and the expected force F and/or torque T data have been measured by the sensor.

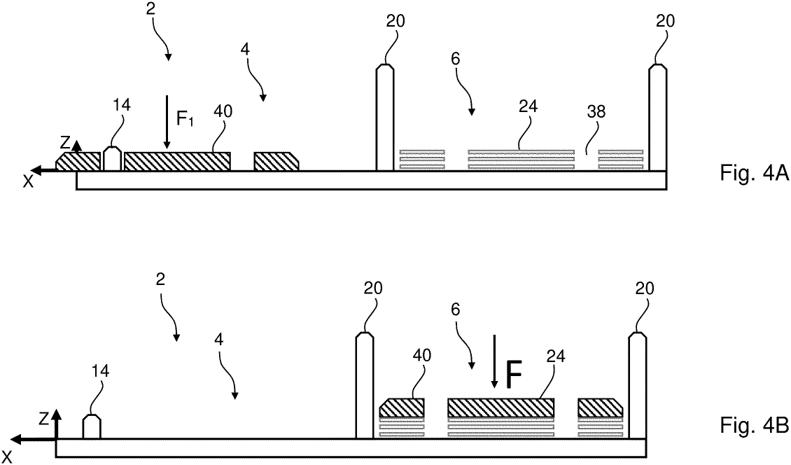

FIG. 4A illustrates another view of the changing station 2 shown in FIG. 3A and FIG. 3B in a configuration, in which the detection pins 14 have been received by and thus aligned with the holes in the head 40. A predefined force F₁ is applied to press the head 40 downwards (along the axis Z). By using one or more positioning sensors of the robot arm, to which the surface treatment tool (see FIG. 2) is attached, it is possible to detect the vertical position of the head 40. Based on this vertical position measurement, a reference level (the position in which the z value is zero) is established.

FIG. 4B illustrates another view of the changing station 2 shown in FIG. 3A and FIG. 3B. In this configuration, the head 40 is placed on the top of a stack of surface treatment media 24 arranged in the receiving area of the attachment portion 6 of the changing station 2. It can be seen that the receiving area is surrounded by rod-shaped media holders 20.

A downwardly directed (along the axis Z) force F is applied to the head 40. Accordingly, the head 40 presses against the stack of surface treatment media 24 and one piece of surface treatment media 24 is attached to the head 40. In an embodiment, the applied force is within the range 5-100 N.

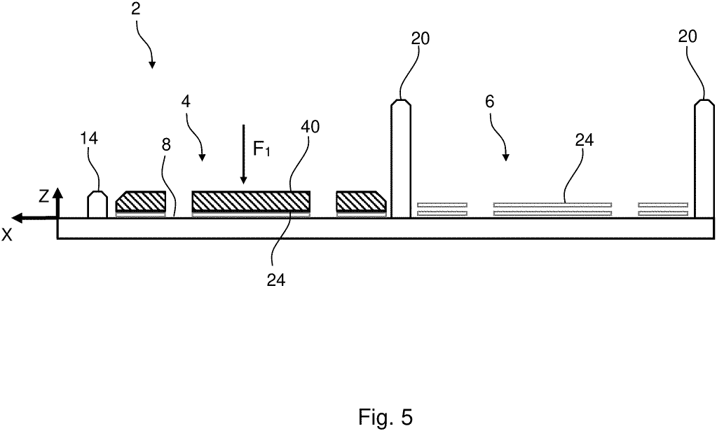

FIG. 5 illustrates another view of the changing station 2 shown in FIG. 4B. In this configuration, the head 40 is moved back to the original position to check if the surface treatment media 24 has been successfully attached to the head 40. By applying a force F₁ corresponding to the force explained and shown with reference to FIG. 4A and using one or more positioning sensors of the robot arm, to which the surface treatment tool (see FIG. 2) is attached, it is possible to detect the vertical position of the head 40 and thus determine the distance between the support member 8 of the detachment portion 4 of the changing station 2. If the distance between the support member 8 of the detachment portion 4 of the changing station 2 corresponds to the expected value, it is concluded that a single surface treatment media 24 has been successfully attached to the head 40. If two layers of surface treatment media 24 have been attached to the head 40, the detected distance would be larger than the expected distance. Accordingly, the test procedure will reveal if more than a single surface treatment medium 24 is attached to the head 40.

In an embodiment, the surface treatment medium 24 is a piece of sandpaper having a thickness of 0.5 mm. In this case, the expected value would be 0.5 mm.

In an embodiment, the surface treatment medium 24 is a piece of sandpaper having a thickness of 1.0 mm. In this case, the expected value would be 1.0 mm.

In an embodiment, the surface treatment medium 24 is a piece of sandpaper having a thickness of 1.5 mm. In this case, the expected value would be 1.5 mm.

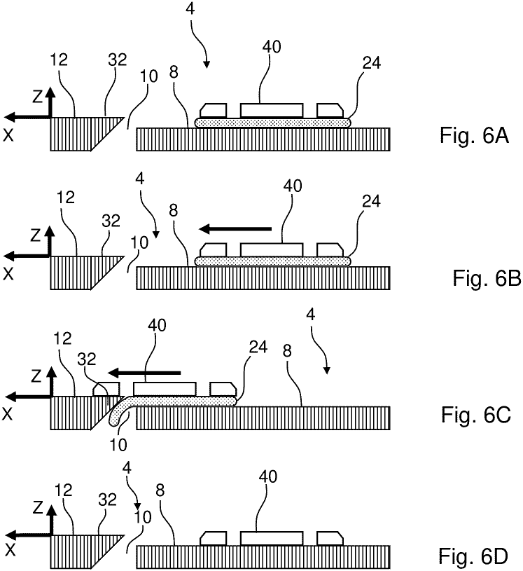

FIG. 6A illustrates a cross-sectional view of a detachment portion 4 of a changing station 2 according to an embodiment. A single piece of a surface treatment medium 24 is attached to the head 40 of a surface treatment tool (not shown). The head 40 with the surface treatment medium 24 rests on the support member 8 of the detachment portion 4 of the changing station 2.

The detachment portion 4 comprises a plate 12 having a distal portion formed as a separation blade 32. The separation blade 32 is provided a short distance from the adjacent edge of the support member 8. The top portion of the plate 12 and the separation blade 32 are provided in a slightly higher level than the support member 8. Hereby, a gap 10 is provided between the separation blade 32 and the support member 8. This gap 10 is large enough to receive an edge portion of the surface treatment medium 24.

In an embodiment, the plate 12 and the separation blade 32 are attached to each other. In an embodiment, the plate 12 and the separation blade 32 are integrated to constitute a one-piece body.

In an embodiment, the separation blade 32 is movably arranged with respect to the support member 8. Hereby, the magnitude of the gap 10 can be changed by moving the separation blade 32. Attachment of the separation blade 32 may be carried out using screws or other attachment members.

The distance between the head 40 and the support member 8 is measured by one or more positioning sensors of the robot arm, to which the surface treatment tool (see FIG. 2) is attached. Hereby, it is possible to detect the vertical position of the head 40.

FIG. 6B illustrates another cross-sectional view of the detachment portion 4 shown in FIG. 6A. It can be seen that the head 40 of a surface treatment tool (not shown) is moved to the left along the X axis. The movement of the head 40 is indicated by an arrow.

FIG. 6C illustrates another cross-sectional view of the detachment portion 4 shown in FIG. 6B. It can be seen that the surface treatment medium 24 has entered the gap 10 between the separation blade 32 and the support member 8. Accordingly, the surface treatment medium 24 is being detached from the head 40.

FIG. 6D illustrates another cross-sectional view of the detachment portion shown in FIG. 6C. In this configuration, the head 40 is placed in the same position as shown in FIG. 6A and the vertical position of the head 40 (or the distance between the head 40 and the support member 8) is detected by one or more positioning sensors of the robot arm, to which the surface treatment tool is attached (see FIG. 2). Hereby, it is possible to detect the vertical position of the head 40.

If the distance between the head 40 and the support member 8 is de- creased as expected (so that the distance between the head 40 and the support member 8 corresponds to the value referred to when describing FIG. 6A), it is concluded that the surface treatment medium 24 has been successfully removed.

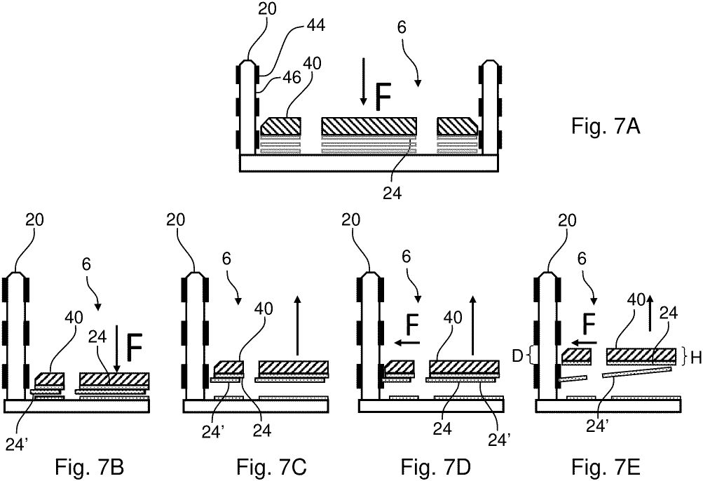

FIG. 7A illustrates a cross-sectional view of an attachment portion 6 of a changing station according to an embodiment. A head 40 of a surface treatment tool (not shown) rests on a stack of surface treatment media 24 placed on the support member of the attachment portion 6. The stack is surrounded by media holders 20 provided as rod-shaped stop members 20. The media holders 20 comprise a surface structure adapted for separating adjacent pieces of surface treatment media 24 that are attached to each other. The surface structure of the media holders 20 comprises alternating portions of protruding structures 44 and groove structures 46, respectively. In FIG. 7A, the magnitude of the protruding structures 44 and the groove structures 46 have been exaggerated for illustrative purposes.

In order to attach a surface treatment medium 24 to the head 40, a force F is applied from the head 40 towards the stack of surface treatment media 24.

FIG. 7B illustrates another cross-sectional view of the left-side portion of the attachment portion 6 shown in FIG. 7A. The head 40 and the surface treatment media 24 attached thereto are moved slightly to the right using a predefined force.

FIG. 7C illustrates another cross-sectional view of the portion of the attachment portion 6 shown in FIG. 7B in a configuration, in which the head 40 and the surface treatment medium 24 attached thereto are raised from the remaining surface treatment media 24 of the stack. Accordingly, the head 40 and the surface treatment medium 24 attached thereto are moved upwards. It can be seen that two surface treatment media 24 are attached to the head 40.

FIG. 7D illustrates another cross-sectional view of a portion of the attachment portion 6 shown in FIG. 7C. In order to remove the lowermost surface treatment medium 24 from the surface treatment medium 24 that is in contact with and attached to the head 40, the head 40 is moved towards the adjacent media holder 20.

FIG. 7E illustrates another cross-sectional view of a portion of the attachment portion 6 shown in FIG. 7D. In order to remove the lowermost surface treatment medium 24 from the surface treatment medium 24 that is in contact with and attached to the head 40, the head 40 is moved up in a direction away from the support member of the attachment portion 4 while the head 40 is pressed towards the adjacent media holder 20 in order to keep the head 40 and the surface treatment media 24 in contact with the adjacent media holder 20. Accordingly, a protruding structure 44 will detach the lowermost surface treatment medium 24 from the uppermost surface treatment medium 24 and the head 40 has been received by the groove structure 46 and the lowermost surface treatment medium 24 has not. Basically, the (sticking) uppermost surface treatment medium gets into the groove structure 46 and hereby gets separated from the lowermost surface treatment medium 24. In FIG. 7E it can be seen that the distance D between adjacent protruding structures 44 is large enough to allow the groove structure 46 to receive the uppermost surface treatment medium 24 and the head 40. The thickness H of the uppermost surface treatment medium 24 and the head 40 is indicated. Since the uppermost portion of the head 40 tapers, it is not required that D is larger than H. Moreover, the head 40 may be made of a compressible material. If the head 40 is made of a compressible material, it is possible to detach the lowermost surface treatment medium 24 even if H is slightly larger than D because the lowermost portion of the head 40 may be received by the groove structure 46 hereby enabling the lowermost portion of the head 40 and the uppermost surface treatment medium 24 to be received by the groove structure 46.

If the lowermost surface treatment medium 24 protrudes relative to the uppermost surface treatment medium 24 and the head 40, it is possible to remove the lowermost surface treatment medium 24 by placing a part of it in a groove structure 46 and moving the uppermost surface treatment medium 24 and the head 40 along the length of the adjacent media holder 20.

List of reference numerals

| | |
|---|---|
| 2 | Changing station (grit changer) |
| 4 | Detachment portion |
| 6 | Attachment portion |
| 8 | Support member |
| 10 | Gap |
| 12 | Plate |
| 14, 14′ | Pin |
| 18, 18′ | Mounting structure |
| 20 | Media holder (stop member) |
| 22 | Base portion (for the media) |
| 24 | Surface treatment media (e.g. a sheet member such as sandpaper) |
| 26 | Robot mounted surface treatment tool (e.g. a grinding machine) |
| 28 | Robot arm |
| 30 | Robot |
| 32 | Separation blade |
| 34, 34′ | Guide pin |
| 36 | Object |
| 38 | Hole |
| 40 | Head (e.g. formed as a pad) |
| 42 | Hole |
| 44 | Surface structure (protruding structure) |
| 46 | Surface structure (groove structure) |
| 48 | Sensor |
| 50 | Frame |
| F, F₁ | Force |
| T | Torque |
| D | Distance |
| H | Thickness |

What is claimed is:

1. A method for automatically attaching a surface treatment medium to a surface treatment tool mounted on a robot arm of a robot having an articulated robot arm, the surface treatment tool comprising a head configured to receive the surface treatment medium, the method comprising:
placing the head on a surface and applying a predefined force to press the head towards the surface when no surface treatment medium is attached to the head;
measuring a first distance between the head and the surface using one or more positioning sensors of the robot arm or the surface treatment tool;
attaching the surface treatment medium to the head and placing the head having the surface treatment medium attached thereto on the surface; and
measuring a second distance between the head and the surface using the one or more positioning sensors of the robot arm or the surface treatment tool when the surface treatment medium is attached to the head.

2. The method according to claim 1, further comprising:
detaching the surface treatment medium from the head;
placing the head on the surface when the surface treatment medium has been removed;
applying the predefined force to press the head towards the surface; and
measuring a third distance between the head and the surface using the one or more positioning sensors of the robot arm or the surface treatment tool.

3. The method according to claim 1, further comprising detecting an orientation of the head by bringing the head into engagement with engagement structures.

4. The method according to claim 3, wherein the head comprises several holes and the engagement structures comprise two detection pins arranged a predefined distance from each other, wherein the detection pins are configured to be brought into engagement with the holes of the head.

5. The method according to claim 1, further comprising utilizing a changing station that comprises a detachment portion configured to detach a used surface treatment medium from the head and an attachment portion designed and configured to attach a new surface treatment medium to the head.

6. The method according to claim 5, wherein one or more guide pins are provided in the attachment portion and one or more detection pins are protruding from the surface of the detachment portion.

7. The method according to claim 1, further comprising removing a lowermost surface treatment medium, when more than one surface treatment media are attached to the head, by bringing at least a most distal portion of the head into contact with a media holder and moving the head along a length of the media holder.

8. The method according to claim 7, wherein the media holder is formed as a pin comprising alternating portions of protruding structures and groove structures.

9. A changing station for automatically attaching a surface treatment medium to a surface treatment tool mounted on a robot arm of a robot having an articulated robot arm, the surface treatment tool comprising a head configured to receive the surface treatment medium, the changing station comprising:
a detachment portion comprising a support member configured to receive the head and two detection pins protruding from the support member, the two detection pins being arranged a predefined distance from one another; and
an attachment portion comprising a base portion and two guide pins protruding from the base portion, wherein the two guide pins are arranged a distance from one another equal to the predefined distance of the two detection pins.

10. The changing station according to claim 9, wherein the guide pins are detachably attached to the base portion.

11. The changing station according to claim 9, wherein the base portion is configured to receive a stack of surface treatment media and the attachment portion comprises a plurality of media holders shaped as pin-formed stop members that surround the base portion.

12. The changing station according to claim 11, wherein each of the plurality of media holders comprises alternating portions of protruding structures and groove structures.

13. The changing station according to claim 11, wherein the detachment portion comprises a separation blade provided at a distance from an adjacent edge of the support member, wherein the separation blade is provided at a higher elevation than the support member.

14. A robot system comprising:
a changing station according to claim 9;
a robot comprising a robot arm; and
a surface treatment tool attached to the robot arm, the surface treatment tool comprising a head configured to receive a surface treatment medium;
wherein the robot system is configured to attach a surface treatment medium to the surface treatment tool and to place the head on a surface and apply a predefined force to press the head towards the surface when no surface treatment medium has been attached to the head.

15. The robot system according to claim 14, further comprising:
an attachment unit configured to attach the surface treatment medium to the head and to place the head on a support member of the attachment unit when the surface treatment medium is attached to the head; and
a measuring unit configured to measure a first distance between the head and the support member using one or more positioning sensors of the robot arm or the surface treatment tool.
